(19) United States
(12) Patent Application Publication
(10) Pub. No.: US 2012/0266826 A1
(43) Pub. Date: Oct. 25, 2012

(54) SYSTEM, METHOD AND APPARATUS FOR THERMALLY CONDUCTIVE REFRACTORY TILES FOR WASTE TO ENERGY BOILER WALLS

(75) Inventors: Patrick M. Stephan, Northborough, MA (US); Jeffrey M. Campbell, Butler, PA (US)

(73) Assignee: SAINT-GOBAIN CERAMICS & PLASTICS, INC., Worcester, MA (US)

(21) Appl. No.: 13/452,404

(22) Filed: Apr. 20, 2012

Related U.S. Application Data
(60) Provisional application No. 61/478,367, filed on Apr. 22, 2011.

(51) Int. Cl. F23M 5/02; F22B 37/36; F27D 1/06

(52) U.S. Cl. 122/6 A; 110/338

(57) ABSTRACT

A refractory tile has a body formed from a refractory material. The body has a front side that defines a front plane, and a rear side that defines a rear plane that is opposite the front plane. A concave portion is formed in the rear side and is contoured to a wall of boiler tubes. The body also has an inclined portion extending from the front plane to the rear plane. The inclined portion is formed at an acute angle with respect to the rear plane. The inclined portion defines an edge at an intersection with the rear plane. The edge directly contacts the wall without a backfill material. The tiles form an array of upper refractory tiles located only on an uppermost row of the array above lower refractory, against the bare wall of boiler tubes.

### CROSS-REFERENCE TO RELATED APPLICATION

This application claims priority under 35 U.S.C. §119(e) to U.S. patent application Ser. No. 61/478,367 entitled “System, Method, and Apparatus for Thermally Conductive Refractory Tiles for Waste to Energy Boiler Walls,” by Stephan et al., filed Apr. 22, 2011, which is assigned to the current assignee hereof and incorporated herein by reference in its entirety.

### BACKGROUND OF THE INVENTION

1. Field of the Disclosure

The present invention relates in general to refractory tiles and, in particular, to a system, method and apparatus for thermally conductive tiles for use in power plants and waste-to-energy systems.

2. Description of the Related Art

It is common practice to cover furnace walls of facilities such as municipal waste incinerators with a firebrick, cements or tile sheath in order to protect the structural elements from the erosive and corrosive effects of combustion. Many of these facilities now include energy recovery systems, often referred to as waste-to-energy systems (or WTE systems), which are designed to use the heat generated during the combustion process. Energy recovery systems typically utilize a boiler with an array of metal tubes placed at the periphery of the furnace or incinerator, such as in the walls. Water is circulated through the tubes as a heat transfer medium and forms steam. Given the harsh environment of the furnace, it is desirable to protect the heat exchanger array with a refractory material. However, unlike conventional thermal insulation refractory bricks used in common furnaces, the refractory tiles that line a heat exchanger are intended to conduct heat.

Fluidized bed boilers are a type of energy producing system that uses solids conduction for about half of the heat transfer to generate steam. The solids conduction is typically achieved by circulating a hot sand along with burning fuel. The hot sand is conveyed upward via a forced draft fan and migrates to the walls of the vessel as it rises through the combustor. Once at the walls, the hot sand falls down the boiler tubes to heat the boiler feed water circulating therein. The downward cascading flow of hot sand causes a sandblasting effect on the tubes that causes varying degrees of metal erosion.

Boilers are designed with various forms of refractory cement to line the bottom of the combustor walls. The refractory reduces corrosion from the reducing atmosphere that is present below a secondary air injection level of the system. The uppermost tiles of conventional refractory linings have a horizontal ledge at the interface with the tube wall. The ledge is subjected to the falling sand and is eroded by it. The erosion is also known as stick slip erosion, and is commonly referred to as “thumbprint.” Thumbprint is caused by sliding friction as the sand and ash flow away from the tube wall and into the bottom of the combustor. The ash appears to build up to an angle of repose on the refractory ledge. When the pile of ash exceeds its stable angle of repose, the top layer slides off and leaves a slightly shallower and more stable slope. As the ash slides off the top of the pile it wipes across the tubes where the thumbprinting occurs.

Some boiler operators apply a hardened metal coating (e.g., metal spray, weld overlay, or ceramic paint) at the high wear area to preserve the tubes. However, these coatings have a finite life, and are costly and time consuming to apply. Other solutions have included the use of more durable cast steel blocks at the wall interface.

Despite continued improvements in refractory tile systems for boiler tube wall applications, the industry continues to demand improved designs and particularly, improved durability, efficiency, safety, and repair ease.

### SUMMARY

Embodiments of a system, method and apparatus for a refractory tile have a body formed from a refractory material. The body has a front side that defines a front plane, and a rear side that defines a rear plane that is opposite the front plane. A concave portion is formed in the rear side and is adapted to contour to the wall of the boiler tubes. The body of tile also has an inclined portion extending from the front plane to the rear plane. The inclined portion is formed at an acute angle with respect to the rear plane. The inclined portion defines an edge at an intersection with the rear plane. The edge is adapted to directly contact the boiler tube wall without a backfill material such as mortar.

The tiles may be used in a boiler system. The tiles form an array of upper refractory tiles and lower refractory (e.g., cement or tiles) adjacent to the outer surfaces of the boiler tubes. The lower refractory is located adjacent to a lower portion of the wall formed by boiler tubes, and the upper refractory tiles are located only on an uppermost row of the array above the lower refractory, where upper portions of the wall of boiler tubes are bare, and the upper refractory tiles are located at an interface between the array and the upper portions of the wall.

The foregoing and other objects and advantages of these embodiments will be apparent to those of ordinary skill in the art in view of the following detailed description, taken in conjunction with the appended claims and the accompanying drawings.

### BRIEF DESCRIPTION OF THE DRAWINGS

So that the manner in which the features and advantages of the embodiments are attained and can be understood in more detail, a more particular description may be had by reference to the embodiments thereof that are illustrated in the appended drawings. However, the drawings illustrate only some embodiments and therefore are not to be considered limiting in scope as there may be other equally effective embodiments.

FIG. 1 is an isometric view of one embodiment of a refractory tile system for a boiler;

FIG. 2 is an isometric view of one embodiment of a refractory tile;

FIG. 3 is a front view of the tile of FIG. 2;

FIG. 4 is a top view of the tile of FIG. 2;

FIG. 5 is a sectional side view of the tile of FIG. 2 taken along the line 5-5 of FIG. 4;

FIG. 6 is a side view of the tile of FIG. 2;

FIG. 7 is a sectional side view of the tile of FIG. 2 taken along the line 7-7 of FIG. 3;

FIG. 8 is an isometric view of another embodiment of a refractory tile;

FIG. 9 is a sectional side view of the tile of FIG. 8 taken along the line 9-9 of FIG. 8;

FIG. 10 is a sectional side view of the tile of FIG. 8 taken along the line 10-10 of FIG. 8;

FIG. 11 is an enlarged sectional side view of an upper portion of the tile of FIG. 9; and

FIG. 12 is a sectional top view of an embodiment of an uppermost one of the tiles and the boiler of FIG. 1.

The use of the same reference symbols in different drawings indicates similar or identical items.

### DETAILED DESCRIPTION

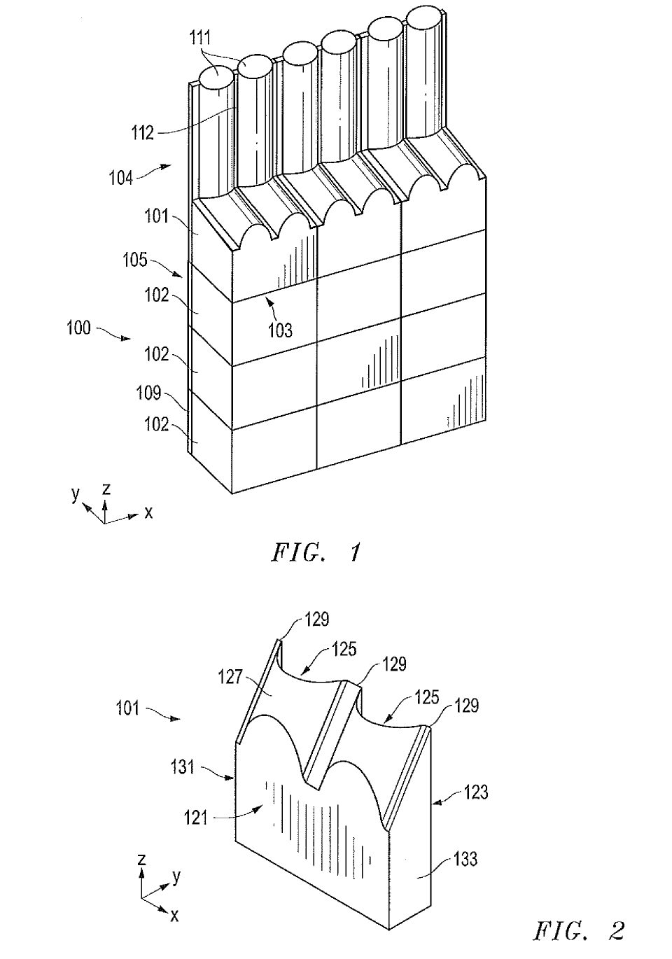

FIG. 1 is an isometric view of an embodiment of a refractory tile system 100 having a plurality of refractory components, such as tiles 101, 102 for covering a wall 104 of a boiler. Tiles 102 may comprise refractory cement or tiles. The tiles 101, 102 of refractory tile system 100 are stacked in an array. Each refractory tile 101, 102 has a front surface 103 and a back surface 105. The back surfaces 105 are contoured to place the refractory tiles in close proximity to the wall formed by boiler tubes 111. The array also increases the surface area coverage of the tubes by the refractory tiles to facilitate efficient heat transfer. The front surface 103 is generally referred to as a hot surface because it is proximate to the direct heat from an incinerator (not shown). The back surface 105 is generally referred to as a cold surface because it is not subject to direct heat like the front surface 103 and thus is generally cooler than the front surface 103. Each refractory tile 101, 102 also is anchored to the partitions 112 that extend between and join the tubes 111. As is known in the art, anchoring may comprise mounting the tiles to steel hardware that extends perpendicularly from the partitions 112.

In conventional designs, a gap region 109 is located between the tiles 102 and the wall 104. Generally, the gap region 109 is filled with a cement or mortar. The mortar also may be used to modify thermal transfer properties of the system, such as by improving thermal contact between the refractory tiles and the wall of the boiler. In addition, mortar provides additional support for anchoring the tiles 102 to the wall 104.

As shown in FIG. 1, the tiles 101, 102 may be used in a boiler system, such as with the combustor of a fluidized bed boiler system. The tiles form an array of upper refractory tiles and lower refractory adjacent to the outer surfaces of the boiler tubes 111. The lower refractory 102 are located adjacent to a lower portion of the wall formed by boiler tubes 111, and the upper refractory tiles 101 are located only on an uppermost row of the array above the lower refractory tiles 102, where upper portions of the wall of boiler tubes are bare, and the upper refractory tiles are located at an interface between the array and the upper portions of the wall.

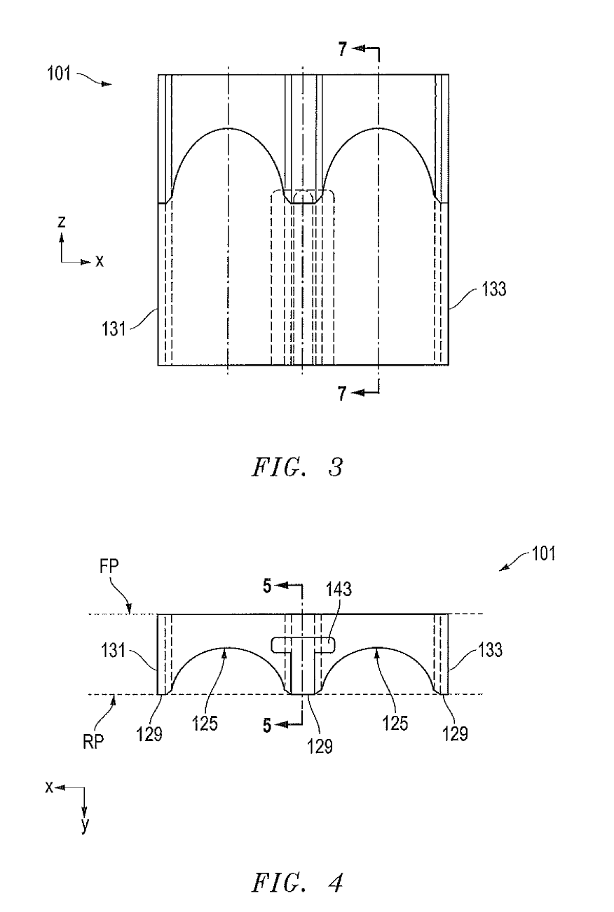

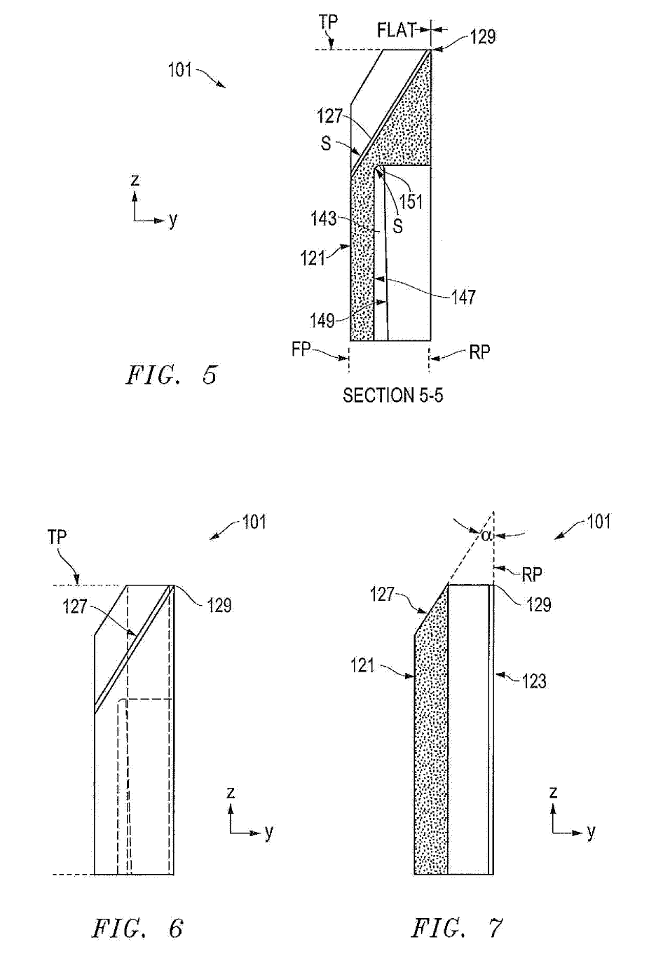

In some embodiments (FIGS. 2-7), each of the upper refractory tiles 101 may comprise a body formed from a refractory material. The body may have a generally rectangular sectional shape. An x-y-z coordinate system is provided in the drawings for ease of reference. For example, as shown in FIGS. 4 and 5, the body has a front side 121 that defines a front plane FP (in an x-z plane), a rear side 123 that defines a rear plane (also in an x-z plane) that is opposite the front plane. A concave portion 125 (e.g., two shown) is formed in the rear side 123 and is adapted to contour to the wall of the boiler tubes 111 (see FIG. 1).

The body of tile 101 also has an inclined portion 127 extending from the front plane FP to the rear plane RP. The inclined portion 127 is formed at an acute angle α (see FIG. 7) with respect to the rear plane RP. The acute angle α of the inclined portion may be in a range of 45°<α<70°, or about 55°<α<65° in other embodiments. The inclined portion 127 defines an edge 129 at an intersection with the rear plane RP. The edge 129 is adapted to directly contact the boiler tube wall without a backfill material such as mortar.

In some embodiments, the edge 129 intersects the rear plane RP within 0.10 inches (i.e., in the y-direction) of the rear plane RP, or within 0.03 inches in other embodiments. For example, as shown in FIGS. 5 and 6, the intersection defines a top plane TP (an x-y plane) of the body that is orthogonal to the rear plane RP. A flat (FIG. 5; also formed in an x-y plane) extends in the top plane TP and has a width of no more than about 0.10 inches (in the y-direction), or no more than about 0.03 inches in other embodiments. In some embodiments, the edge 129 is radiused in a range of 0.06 to 0.13 inches.

The edge 129 also may extend along the concave portion 125. The body has first and second side walls 131, 133 extending between the front side 121 and the rear side 123. The rear side 123 has a rear profile that extends from the first side wall 131 to the second side wall 133 and includes the concave portion 125. The edge 129 extends continuously along an entire length of the rear profile.

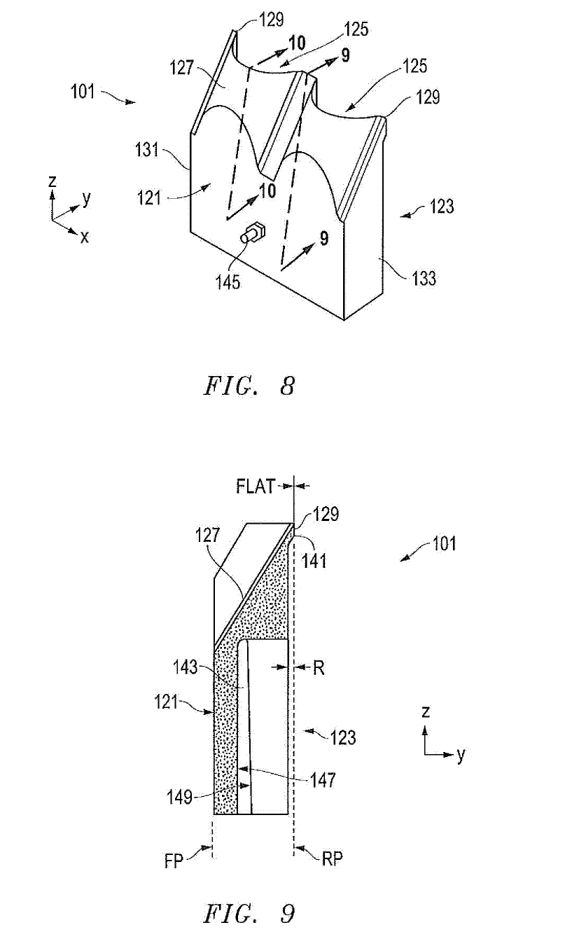

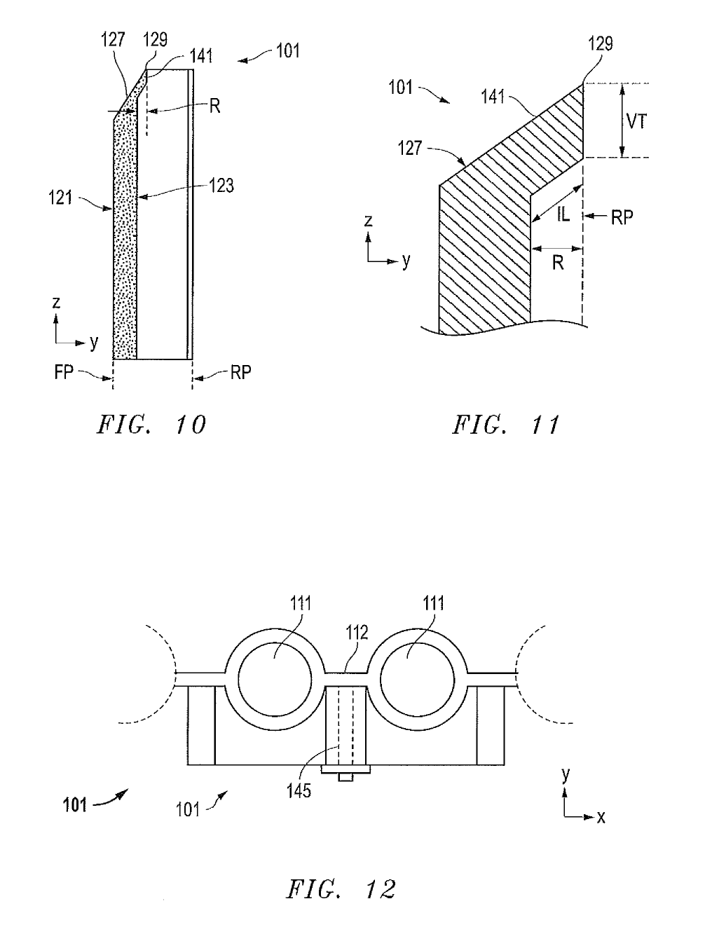

In other embodiments (FIGS. 8-10), the edge 129 may be located on a protrusion 141 extending from the rear side 123. The protrusion 141 extends to the rear plane RP. A remainder of the rear side 123 is recessed R from the rear plane RP toward the front plane FP, such as to accommodate backfill material between tile 101 and the boiler tube wall. As shown in the enlarged view of FIG. 11, the protrusion 141 may have an inclined length IL of about 0.25 to 0.50 inches, and a vertical thickness VT (along the z-axis) of about 0.25 to 0.50 inches, depending on the grain size of the material used to form tile 101.

Again referring to FIGS. 4, 5 and 9, the body may be provided with a void 143 that is adapted to receive and engage hardware 145 (FIGS. 8 and 12) extending horizontally (in the y-direction) from a portion (e.g., partitions 112) of the boiler tube wall. For example, the refractory tile 101 may be mounted or bolted to the hardware 145 extending from a portion of the boiler tube wall and completely through the body from the rear plane RP to the front plane FP, as shown in FIGS. 8 and 12.

The void 143 has a vertical slot that tapers vertically (in the z-direction) in width in a range of about 1.0° to 3° from vertical, as shown. The vertical slot causes the edge 129 to move toward and directly contact the boiler tube wall when the refractory tile 101 is mounted to the hardware 145. The vertical slot may have a front wall 147 that is vertical, and a rear wall 149 (FIGS. 5 and 9) that is skewed with respect to the front plane FP in said range. In other embodiments, the range may be about 1.5° to 2.5° from vertical.

The inclined portion 127 has an outer surface. The void 143 in the body is adapted to receive and engage the hardware 145 extending from the boiler tube wall. The void 143 has an upper end 151 with an inner surface, and the inner surface is spaced apart S (FIG. 5) from the outer surface in a range of 0.25 to 0.50 inches, depending on grain size.

Embodiments of the refractory tiles may be formed from a thermally conductive refractory ceramic material, such as a composite material including silicon carbide and a metallic phase including silicon. According to one embodiment, the refractory tile 201 can include not less than about 80 wt % silicon carbide, such as not less than about 85 wt % silicon carbide. According to another embodiment, the refractory tile 201 can include not less than about 90 wt % silicon carbide, such as not less than about 95 wt % silicon carbide.

In other embodiments, the refractory tiles may be formed from a composite material including a metallic phase, such as metal silicon, oftentimes elemental silicon. According to one embodiment, the body of the refractory tile 201 can include not greater than about 30 wt % silicon, such as not greater than about 25 wt % silicon, or not greater than about 20 wt % silicon, or still, not greater than about 15 wt % silicon. According to a particular embodiment, the body of the refractory tile 201 can include an amount of silicon within a range of between about 4.0 wt % silicon and 25 wt % silicon, such as within a range of between about 5.0 wt % to about 20 wt %, and in particular within a range of between about 6 wt % to 20 wt %.

Still, the silicon content can be reduced given the processing of the refractory tile material, including for example, in situ reaction of free silicon with free carbon in a silicon carbide-based body. As such, in one particular embodiment, the body includes a silicon reaction bonded silicon carbide composition (i.e., Si/SiC/SiC), such that the silicon content is not greater than about 3.0 wt %, or not greater than about 2.0 wt %, or even not greater than about 1.0 wt % silicon. In a particular embodiment, the body of the refractory tile 201 can have a silicon content within a range of between about 0.05 wt % and about 3.0 wt % silicon, such as within a range of between about 0.05% and about 1.0 wt % silicon.

In further reference to the material of the refractory tile 201, according to another embodiment, the body of the tile includes a material having a thermal conductivity of not less than about 18 W/mK at 1200° C., such as not less than about 20 W/mK at 1200° C., or not less than about 25 W/mK at 1200° C. Still, in another embodiment, the thermal conductivity of the tile material is greater, such as not less than about 30 W/mK at 1200° C., or not less than about 35 W/mK at 1200° C. Materials meeting certain characteristics discussed above include ADVANCER® CN-703, Nitride Bonded Silicon Carbide, CRYSTAR® RB, Reaction Bonded Silicon Carbide, SILIT® SK, Reaction Bonded Silicon Infiltrated Silicon Carbide (SiSiC).

In further reference to the characteristics of the refractory tile 201, the tile can be a dense material. According to one embodiment, the refractory tile 201 has a porosity of not greater than about 5.0 vol %, such not greater than about 3.0 vol %, or still, not greater than about 1.0 vol %. In one particular embodiment, the porosity of the refractory tile 201 is less than 1.0 vol %. Other embodiments of tiles have a porosity of about 14 to 22 vol %.

As stated above, the refractory tile 201 can be a dense material, and in addition to the porosities described above, according to one embodiment the bulk density of the material is not less than about than about 2.85 g/cm³. In another embodiment, the material comprising the main body has a bulk density of not less than about 2.90 g/cm³, such as not less than about 2.95 g/cm³, or not less than about 3.00 g/cm³. Such density provides a durable refractory tile that can have enhanced mechanical and chemical resistance, thereby improving the thermal conductivity of the tile and the operable lifetime.

The embodiments disclosed herein have several advantages. The tapered tiles have no horizontal surfaces and provide a drainage path for the downward cascading sand in the boiler. The inclined surfaces of the tiles cause the sand to flow away from the tubes and back into the boiler without washing against the wall of steel tubes. These designs reduce or eliminate thumbprinting at the interface between the tube wall and the refractory tiles. The uppermost row of tapered tiles are unique in that the entire length of their upper edges are sharp and contoured to the tube wall without horizontal ledges for ash accumulation.

This written description uses examples to disclose the embodiments, including the best mode, and also to enable those of ordinary skill in the art to make and use the invention. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Note that not all of the activities described above in the general description or the examples are required, that a portion of a specific activity may not be required, and that one or more further activities may be performed in addition to those described. Still further, the orders in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

1. A refractory tile, comprising:
a body formed from a refractory material, the body having a front side that defines a front plane, a rear side that defines a rear plane that is opposite the front plane, a concave portion formed in the rear side and adapted to contour to a boiler tube wall, the body also having an inclined portion extending from the front plane to the rear plane, the inclined portion is formed at an acute angle α with respect to the rear plane, and the inclined portion defines an edge at an intersection with the rear plane.

2. A refractory tile according to claim 1, wherein the edge is adapted to directly contact the boiler tube wall without a backfill material.

3. A refractory tile according to claim 1, wherein the edge intersects the rear plane within 0.10 inches of the rear plane.

4. A refractory tile according to claim 1, wherein the edge intersects the rear plane within 0.03 inches of the rear plane.

5. A refractory tile according to claim 1, wherein the intersection defines a top plane of the body that is orthogonal to the rear plane, and a flat extending in the top plane has a width of no more than about 0.10 inches.

6. A refractory tile according to claim 5, wherein the width of the flat is no more than about 0.03 inches.

7. A refractory tile according to claim 1, wherein the edge is radiused in a range of 0.06 to 0.13 inches.

8. A refractory tile according to claim 1, wherein the edge also extends along the concave portion.

9. A refractory tile according to claim 1, wherein the body has first and second side walls extending between the front side and the rear side, the rear side has a rear profile that extends from the first side wall to the second side wall and includes the concave portion, and the edge extends along an entire length of the rear profile.

10. A refractory tile according to claim 1, wherein the edge is located on a protrusion extending from the rear side, the protrusion extends to the rear plane, and a remainder of the rear side is recessed from the rear plane toward the front plane.

11. A refractory tile according to claim 10, wherein the protrusion has an inclined length of about 0.25 to 0.50 inches, and a vertical thickness of about 0.25 to 0.50 inches.

12. A refractory tile according to claim 1, wherein the body has a void that is adapted to receive and engage hardware extending from a portion of the boiler tube wall, the void has a vertical slot that tapers vertically in width in a range of about 1.0° to 3° from vertical, such that the vertical slot causes the edge to move toward and directly contact the boiler tube wall when the refractory tile is mounted to the hardware.

13. A refractory tile according to claim 12, wherein the vertical slot has a front wall that is vertical, and a rear wall that is skewed with respect to the front wall in said range, and the range is about 1.5° to 2.5° from vertical.

14. A refractory tile according to claim 1, wherein the acute angle α of the inclined portion is in a range of 45°<α<70°.

15. (canceled)

16. A refractory tile according to claim 1, wherein the inclined portion has an outer surface, the body has a void that is adapted to receive and engage hardware extending from a portion of the boiler tube wall, the void has an upper end with an inner surface, and the inner surface is spaced apart from the outer surface in a range of 0.25 to 0.50 inches.

17. A refractory tile according to claim 1, wherein the refractory tile is adapted to be mounted to hardware extending from a portion of the boiler tube wall and completely through the body from the rear plane to the front plane.

18. A refractory tile according to claim 1, wherein the refractory material comprises a thermally conductive refractory composite material.

19. A refractory tile according to claim 18, wherein the refractory material comprises silicon carbide and a metallic phase including silicon.

20. A boiler system, comprising:
a boiler having a plurality of boiler tubes with outer surfaces that form a wall;
an array of upper refractory tiles and lower refractory adjacent to the outer surfaces of the boiler tubes, the lower refractory is located adjacent to a lower portion of the wall, and the upper refractory tiles are located only on an uppermost row of the array above the lower refractory, and each of the upper refractory tiles comprises:
a body formed from a refractory material, the body having a front side that defines a front plane, a rear side that defines a rear plane that is opposite the front plane, a concave portion formed in the rear side and adapted to contour to a boiler tube wall, the body also having an inclined portion extending from the front plane to the rear plane, the inclined portion is formed at an acute angle α with respect to the rear plane, and the inclined portion defines an edge at an intersection with the rear plane.

21. A boiler system according to claim 20, wherein upper portions of the boiler tubes are bare, and the upper refractory tiles are located at an interface between the array and the upper portions in a combustor of a fluidized bed boiler system.

22-39. (canceled)
